(19) United States
(12) Patent Application Publication
(10) Pub. No.: US 2025/0200425 A1
(43) Pub. Date: Jun. 19, 2025

(54) OPTIMIZATION OF ROBOTIC PROCESS AUTOMATION (RPA)

(71) Applicant: INTERNATIONAL BUSINESS MACHINES CORPORATION, Armonk, NY (US)

(72) Inventors: Zachary A SILVERSTEIN, Georgetown, TX (US); Martin G KEEN, Cary, NC (US); Mu QIAO, Belmont, CA (US); Jeremy R FOX, Georgetown, TX (US)

(73) Assignee: INTERNATIONAL BUSINESS MACHINES CORPORATION, Armonk, NY (US)

(21) Appl. No.: 18/540,596

(22) Filed: Dec. 14, 2023

(51) Int. Cl. G06N 20/00; H04L 51/02

(52) U.S. Cl. CPC G06N 20/00; H04L 51/02

(57) ABSTRACT

Various embodiments are provided herein for optimizing Robotic Process Automation (RPA) in a computing environment. At least one of natural language processing (NLP) and machine learning is used to analyze a conversation of a user in real-time, thereby identifying one or more personality traits. The identified personality traits are leveraged to determine an appropriate communication style configured to be used by an RPA chatbot to use when persuading the user to accept an Artificial Intelligence (AI) driven decision.

### BACKGROUND

The present invention relates in general to computing systems, and more particularly, to various embodiments for optimizing Robotic Process Automation (RPA) to develop a persuasive communication style to a user in a computing environment.

### SUMMARY

According to an embodiment of the present invention, a method for optimizing Robotic Process Automation (RPA) in a computing environment having one or more processor devices, is provided. At least one of natural language processing (NLP) and machine learning is used to analyze a conversation of a user in real-time, thereby identifying one or more personality traits. The identified personality traits are leveraged to determine an appropriate communication style configured to be used by an RPA chatbot to use when persuading the user to accept an Artificial Intelligence (AI) driven decision.

An embodiment includes a computer usable program product. The computer usable program product includes a computer-readable storage device, and program instructions stored on the storage device. The computer usable program product includes program instructions for implementing the aforementioned RPA optimization functionality in the computing environment.

An embodiment includes a computer system. The computer system includes a processor, a computer-readable memory, and a computer-readable storage device, and program instructions stored on the storage device for execution by the processor via the memory. In one embodiment, a portion of the computer system is adapted for implementing the aforementioned RPA optimization functionality.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 is a block diagram depicting exemplary relationships between various entities utilized in implementing the present invention.

FIG. 3 is a flow chart diagram of an exemplary functional flow, effecting optimized RPA functionality, according to an embodiment of present invention.

FIG. 4 is an additional flow chart diagram depicting an exemplary functional flow, effecting optimized RPA functionality, according to an embodiment of the present invention.

### DETAILED DESCRIPTION OF THE DRAWINGS

The rapid proliferation of artificial intelligence (AI) and robotic process automation (RPA) technologies has enabled organizations to automate and optimize a wide range of tasks. For instance, RPA chatbots are programmed to perform pre-defined sets of tasks and can be used to automate a variety of processes. RPA bots can be programmed to interact with users in a conversational manner, and are often used in many applications where routine handling of customer tasks takes place. RPA chatbots can also be used to automate complex business processes, such as processes in accounting or supply chain management.

RPA chatbots are often used in conjunction with AI technologies to create more dynamic and intelligent interactions with users. For example, RPA bots can use natural language processing (NLP) to understand user input and respond accordingly. These types of chatbots may also be trained on datasets to recognize patterns and make decisions autonomously based on user input. Sometimes, however, these decisions are difficult for users to understand and accept because of a lack of transparency as to why the AI came to a particular decision. For this reason, Explainable AI (XAI) is a new field of research that attempts to bridge this gap by providing users with more transparent and understandable reasons for the decisions made by such AI and RPA systems.

One of the key challenges in XAI is convincing users to accept AI decisions. This is especially true when the decisions are complex, with many variables and potential outcomes. In these cases, it is important for the user to understand why the AI made the decision it did. This requires a persuasive and personalized communication strategy that, for example, takes into account the user's personality and decision-making history.

This is where an RPA chatbot can be invaluable. An RPA chatbot can leverage NLP and machine learning techniques to analyze the user's conversations in real-life and identify their personality traits. It can then use this information to tailor its communications strategy to the user, making it more likely that they will accept the AI's decision. However, there is currently a lack of solutions that enable an RPA chatbot to optimize its persuasive strategies for user-specific XAI applications.

Accordingly, embodiments of the present invention optimize an RPA chatbot's ability to explain its decisions and receive concurrence from users for those decisions by leveraging NLP and machine learning techniques to analyze user conversations in real-time to identify personality traits of the user. Based on these personality traits and previous interactions with the RPA chatbot, the system uses classification, clustering, decision trees, and reinforcement learning to create a model able to accurately predict a user's decision for a given scenario.

Utilizing input of user conversation and decision-making data, historical user interactions (and decisions corresponding thereto), behavior and decision-making history of the user, and user feedback (collectively, personality traits of the user), the system generates the model according to classified user decisions, grouped similar users, interpreted user conversations in real-time, predicted decisions of the user based on the previous interactions, and an adjusted persuasive strategy to maximize a likelihood of the user accepting the particular decision made by AI.

This model may be utilized to configure the RPA chatbot with the required parameters, such as the user's language and sentiment preferences (i.e., the user's preferred communication style), implement the persuasive strategy, and monitor user interactions and responses to further adjust the RPA chatbot's persuasive strategy, as will be further disclosed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), static random access memory (SRAM), dynamic random access memory (DRAM), read-only memory (ROM), nonvolatile memory, erasable programmable read-only memory (EPROM or Flash memory), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

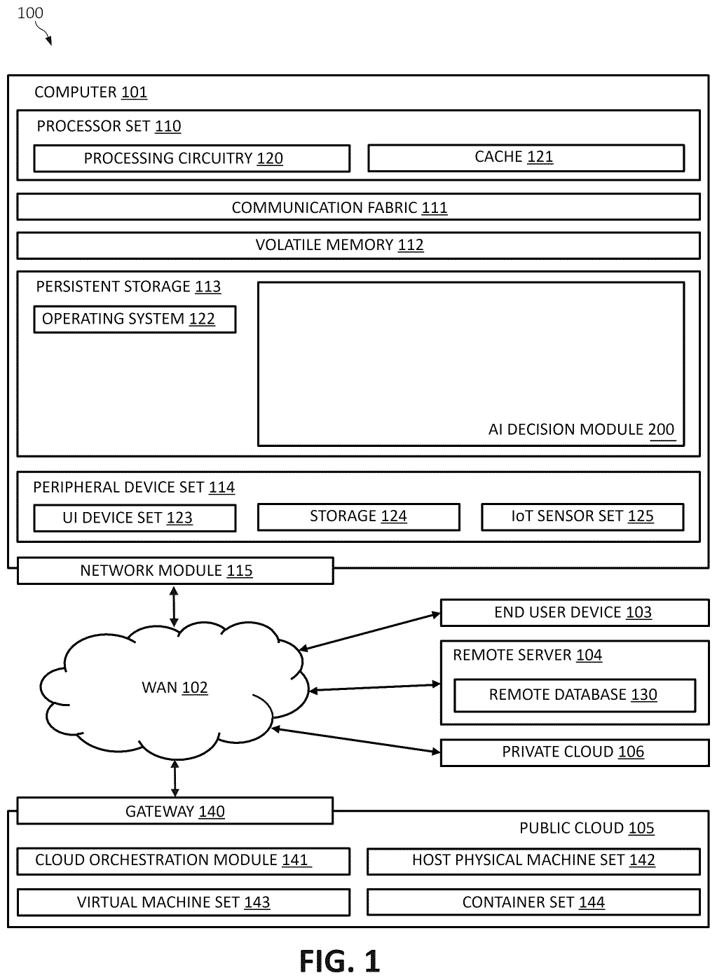

Turning now to FIG. 1, computing environment 100 contains an example of an environment for the execution of at least some of the computer code involved in performing the inventive methods, such as code for acceleration of inflight deployments by AI decision module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

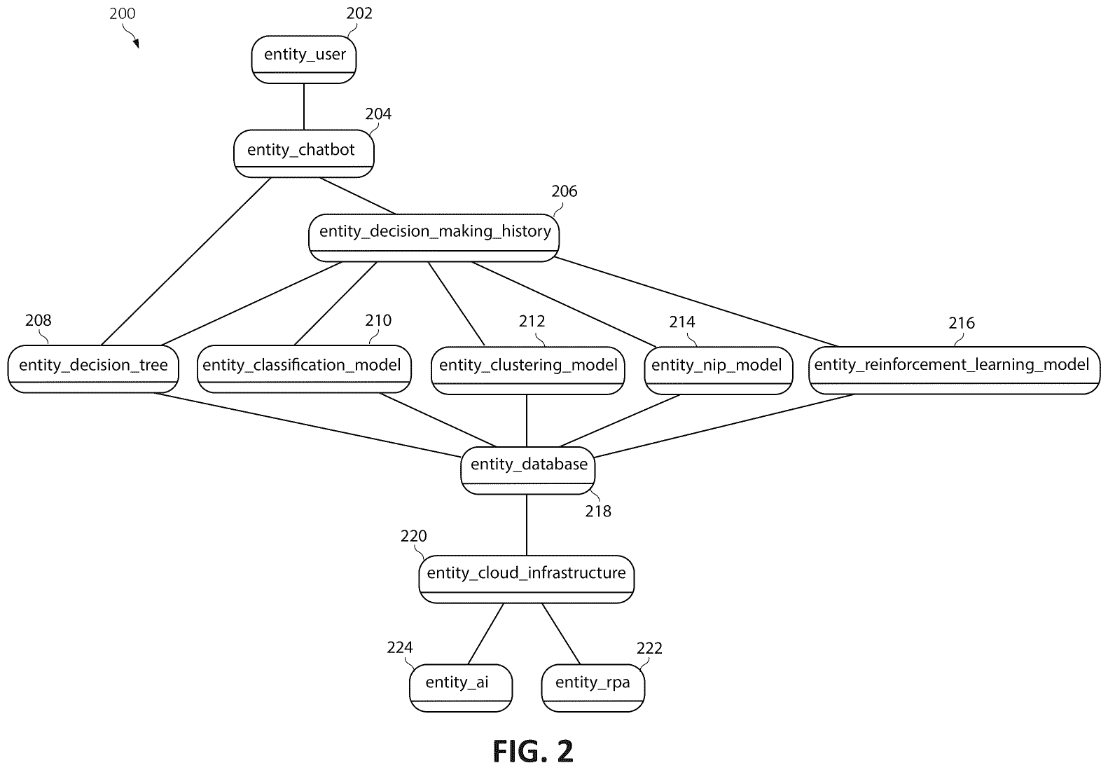

Turning now to FIG. 2, FIG. 2 is an entity relationship diagram 200 depicting a relationship flow of entities utilized in implementing a system of the present invention. In an embodiment, the system includes a user entity 202 interacting directly with a chatbot entity 204 (i.e., the RPA chatbot) to facilitate automating tasks, including those requiring decision(s). The chatbot entity 204 interacts with a decision-making history entity 206 comprising a database containing current and historical decisions made by the user entity 202. This decision-making history entity 206 may interact with various AI, NLP, and machine learning entities, such as an decision tree entity 208, an classification model entity 210, an clustering model entity 212, an NLP model entity 214, and a reinforcement learning model entity 216. The chatbot entity 204 may further directly interact with the decision tree entity 208.

Returning to the suite of AI, NLP, and machine learning entities 208-216, each of the entities 208-216 may interact directly with a database entity 218 containing information related to models, decisions, strategies, RPA chatbot parameters, and the like. The database entity 218 interacts directly with a cloud infrastructure entity 220, which in turn interacts with an RPA entity 222 and an AI entity 224 serviced by the cloud.

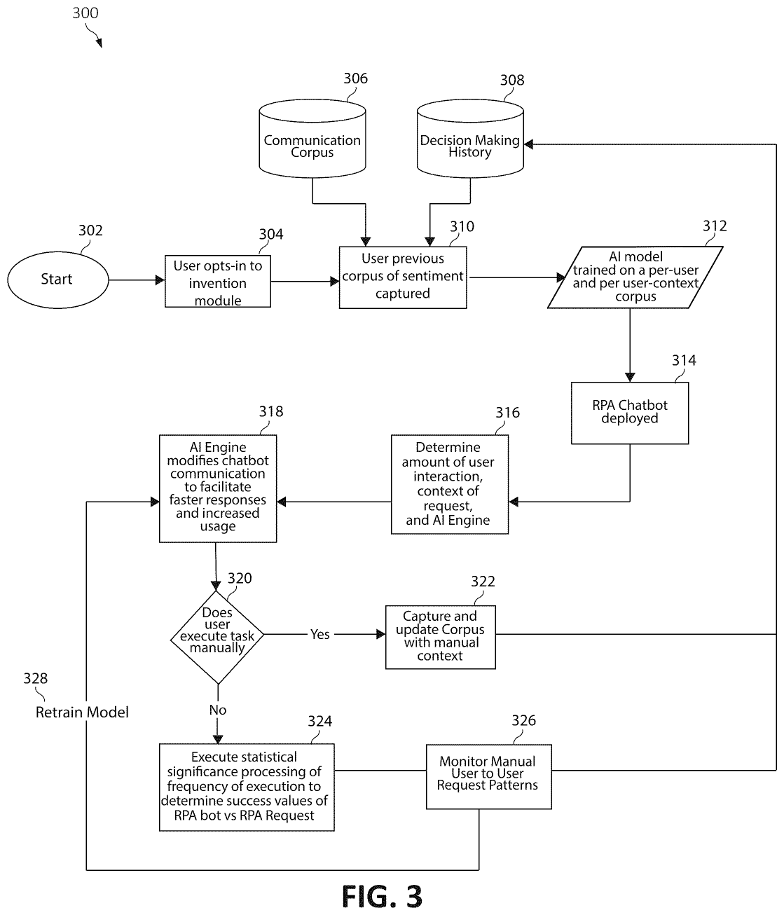

FIG. 3 is a flow diagram of an exemplary functional flow of an RPA chatbot system 300 for effecting optimized RPA functionality. The system 300 is initialized (step 302) by a user opting-in to the optimized RPA chatbot module, which includes enabling/allowing the user's data and decision information to be stored and analyzed by the system 300 (step 304).

The system 300 herein may utilize various information or data sources associated with users (e.g., users who are associated with and/or utilize the RPA chatbot). With respect to users, the data sources may include, for example, any available data sources associated with the user. For example, in some embodiments, a profile (e.g., a cognitive profile) for the user(s) may be generated that represent personality traits of the user and/or a style of communication preferred by the user. Data sources that may be use used to generate a cognitive profile for the user(s) may include any appropriate data sources associated with the user that are accessible by the system (perhaps with the permission or authorization of the user, for example, user's whom opt-in to the inventive functionality). Examples of such data sources include, but are not limited to, audio/video data capturing an environment and/or utterances/expressions made by the user, communication sessions and/or the content (or communications) thereof (e.g., phone calls, video calls, text messaging, emails, in person/face-to-face conversations, etc.), a profile of (or basic information about) the user (e.g., job title, place of work, length of time at current position, family role, etc.), a schedule or calendar (i.e., the items listed thereon, time frames, etc.), projects (e.g., past, current, or future work-related projects), location (e.g., previous and/or current location and/or location relative to other users), social media activity (e.g., posts, reactions, comments, groups, etc.), browsing history (e.g., web pages visited), and online purchases. These data sources may be amalgamated as information stored in the communication corpus 306 (i.e., a communication database).

The system 300 herein may additionally store decision making history, in a decision making history database 308, of the user with respect to decisions associated with an automated task. For example, the decision making history database 308 may include information of whether a user accepted a decision to be performed and/or performed automatically by the system 300. The decision making history database 308 may additionally include information associated with the user rejecting a decision made and/or performed by the system 300.

In some embodiments, the analysis performed on the user's information stored in the communication corpus 306 and the decision making history database 308 includes a cognitive analysis of behavior of the user. For example, at step 310, the user's previous corpus of sentiment is captured by the system 300 through the analysis. This may include classifying natural language, analyzing tone, and analyzing sentiment with respect to, for example, information associated with a particular task and/or decision(s) related to the task, among other available data sources. In some embodiments, NLP, natural language understanding (NLU), and/or natural language generation (NLG) may be used to conduct such analyses (e.g., determine a nature of interactions of between the user and the system 300), determine working parameters, identify patterns (e.g., usage patterns), perform task decisions autonomously, output recommendations to a user, and the like.

In some implementations, the cognitive analysis may include analyses on additional data which is not text-based. For example, Mel-frequency cepstral coefficients (MFCCs) (e.g., for audio content), and/or region-based convolutional neural network (R-CNN) pixel mapping (e.g., for images/videos), as are commonly understood, are used. As such, it should be understood that the methods/systems described herein may be applied to content other than text-based (or alphanumeric) content but also audio content and/or images/videos (i.e., utilizing sensory input devices, such as a camera and/or microphone proximal to the user).

At step 312, the system 300 configures and trains an AI model on a per-user and per-user-context corpus, establishing a ‘persuasive strategy’ specific to the user and context. This configuring/training of the AI model may thus may include generating the AI model based on the elements produced by the cognitive analysis, which are situation and user-specific. For instance, the AI model may be generated to understand and explain a decision to a user working in a research and development domain differently than an AI model generated to understand and explain a decision to a user in executive management. This includes training the model to identify a communication style the user uses/prefers, which may include certain tones, sentiments, verbiage, patterns of speech, volume of speech, speed of speech, and other elements related to discourse.

Once the system 300 is trained, the RPA chatbot is deployed (step 314). In one embodiment, this may include deploying the system 300 as a standalone service (perhaps receiving periodic updates), and in another embodiment this may include deploying the system 300 as an as-a-Service component of the cloud.

As the user begins using the system 300, the system 300 determines the amount of user interaction, information associated with the context of the user's requests, and AI engine (step 316). The AI engine may continually modify communication parameters of the RPA chatbot to facilitate faster responses and encourage increased usage by the user (318). Having trained and deployed the model in the system 300, the system monitors, at step 320, behavior of the user including whether the user is choosing to execute any tasks manually (which otherwise may be performed autonomously by the system 300). If the user does execute a task (and particularly those tasks related to a decision) manually, the system 300 captures and updates the user corpus and decision making history database 308 with the context surrounding the manually performed task (step 322). Otherwise, at step 320, if the user does not execute the task manually, statistical significance processing of frequency of execution is executed to determine success values of the RPA chatbot versus the initial RPA request provided to the RPA chatbot (step 324). The system 300 may monitor manual user-to-user request patterns associated with this information to both store the data associated with the patterns in the decision making history database 308 and retrain the AI model, at step 328. The re-trained AI model may then be used to further modify the AI engine of the system 300 at step 318 in a continuous loop.

In conjunction with FIG. 3, consider the following stages in implementing the optimized RPA chatbot as explained in a reduction to practice.

In a first, pre-configuration stage, user accounts are established by setting-up individual user accounts for each user engaging with the RPA chatbot. This enables the system 300 to keep track of the user's interactions and responses. For instance, the system 300 may observe how often the user approves or rejects an AI decision, and which communication style the user prefers.

The communication corpus 306 and the decision making history database 308 are then created to store the user's conversations and decision-making history. This will allow the application to closely examine the user's behavior and choices over time, and customize the persuasive strategy of the RPA chatbot for each user.

Cloud infrastructure is established to host and manage the system 300, allowing the application to expand to accommodate a large number of users.

The RPA chatbot is then configured with the required parameters, such as the user's language and sentiment preferences, ensuring that the chatbot can accurately interpret the user's conversation and tailor its persuasive strategy accordingly.

In a second, model training stage, the historical user conversations and decision-making data is ingested into the communication corpus 306 and the decision making history database 308. This includes ingesting conversations from instant messaging apps, emails, and any other sources of data discussed previously. The data is pre-processed by cleaning and normalizing the data to ensure it is consistent and accurately represents the user's interactions. This includes removing any irrelevant data, removing any outliers, and correcting any errors in the data.

The classification and clustering models are then trained to accurately categorize the user's decisions and group similar users. The classification model is trained on a dataset of historical user interactions and the corresponding decisions made, to learn how to classify new decisions. For example, in one scenario, the model may classify decisions into two categories: security patch or new product feature. The clustering model is trained on a dataset of the user's behavior and decision-making history, to group similar users and tailor its persuasive strategy accordingly. For example, the model may group users based on their decision-making preferences, and then the chatbot can use this information to determine which persuasive strategy is most likely to be effective for a particular user.

The NLP model is trained to accurately interpret the user's conversations in real-time. This includes training the model to detect the user's tone, sentiment and level of confidence in their responses, and adapt its persuasive strategy accordingly. For example, the model may detect that the user is hesitant to accept the AI's decision, and the RPA chatbot can use this information to adjust its persuasive strategy to be more persuasive.

The decision tree model is trained to predict the user's decision based on their previous interactions with the RPA chatbot. This model is trained on a dataset of the user's past interactions and decisions, to learn how to accurately predict future decisions. For example, the model may learn that a user is more likely to accept an AI decision if it is presented to the user in a certain way (i.e., using certain language, tones, etc. preferable to the user).

The reinforcement learning model is trained to learn from the user's feedback, and adapt its persuasive strategy to maximize the likelihood of the user accepting the AI's decision. This model is trained on a dataset of the user's feedback and responses, to learn how to effectively communicate with the user and persuade them to accept the AI's decision. For example, the model may learn that a user is more likely to accept a decision if they are given more information about the decision, or if they are asked to provide feedback on the decision.

In a third, model implementation stage, each of the trained models are deployed to the cloud infrastructure and integrate them into the system 300. This includes connecting the models to the system 300's database, configuring the models to interact with the RPA chatbot, and testing the models to ensure they are functioning correctly. For example, the classification model is connected to the database, and configured to classify new decisions based on the user's conversations.

The RPA chatbot is configured with the model outputs. This includes setting up the chatbot to interpret the model outputs and use them to determine the most appropriate persuasive strategy for the user. For example, the chatbot will use the classification model's output to decide if it should use an authoritative or persuasive strategy when persuading the user.

The system 300 is tested to make sure it functions correctly. This includes running tests on the system 300 and the models to ensure they are working as expected. For example, the system 300 is tested to make sure the RPA chatbot is able to accurately interpret the user's conversations and tailor its persuasive strategy accordingly.

The system 300 is optimized for production. This includes tuning the models and the RPA chatbot to maximize the effectiveness of the persuasive strategies. For example, the RPA chatbot can be tuned to be more persuasive or authoritative depending on the user's preferences.

The performance of the system 300 is monitored to ensure it is functioning correctly. This includes tracking user interactions and responses and using the data to refine the system 300. For example, the system 300 can monitor user responses to the RPA chatbot's persuasive strategies, and use this data to refine the strategies and make them more effective.

Finally, in a fourth, utilization stage, the user's conversations are analyzed in real-time to understand their preferences and communication tendencies. This includes using NLP to detect the user's tone, sentiment, and level of confidence in their responses. For example, the RPA chatbot can detect if the user is hesitant to accept the AI's decision, and use this information to adjust its persuasive strategy accordingly.

A user's personality type is identified based on these conversations. This includes using the classification and clustering models to accurately classify the user's decisions and group similar users into clusters. For example, the chatbot can use the clustering model to group users based on their decision-making preferences, and leverage this information to determine which persuasive strategy is most likely to be effective for a particular user.

The information from the user's conversations and decision-making history is leveraged to determine the most appropriate communication style for the RPA chatbot to use when persuading the user to accept the AI's decision. This includes using the decision tree model to predict the user's decision based on their previous interactions, and the reinforcement learning model to learn from the user's feedback and adapt its persuasive strategy accordingly. For example, the chatbot can use the decision tree model's output to determine if it should be more authoritative or persuasive when persuading the user, and the reinforcement learning model's output to adjust its strategy to maximize the likelihood of the user accepting the AI's decision.

A performance of the system 300 is monitored to ensure it is functioning correctly. This includes tracking user interactions and responses and using the data to refine the system 300. For example, the application can monitor user responses to the chatbot's persuasive strategies, and use this data to refine the strategies and make them more effective.

In a further example of reduction to practice, the following code snippet implements an NLP model and uses the model to analyze the user's conversations in real-time, by leveraging machine learning algorithms to vectorize the data and train the model on a dataset of the user's conversations and decision-making history:
1 #Train the NLP Model
2 from sklearn.feature_extraction.text import Count Vectorizer
3 from sklearn.model_selection import train_test_split
4 from sklearn.naive_bayes import MultinomialNB
5
6 #Load the dataset
7 data=pd.read_csv(‘data.csv’)
8
9 #Set up the independent and dependent variables
X=data [‘conversations’]
11 y=data [‘decision’]
12
13 #Split the data into training and testing sets
14 X_train, X_test, y_train, y_test=train_test_split (X, y, test_size=0.2, random_state-42)
16 #Vectorize the data
17 vect=CountVectorizer( )
18 X_train_vect=vect.fit_transform(X_train)
19 X_test_vect=vect.transform(X_test)
20
21 #Train the model
22 model=MultinomialNB( )
23 model.fit(X_train_vect, y_train)
24 #Evaluate the model
26 score=model.score(X_test_vect, y_test)
27 print(“The model's accuracy is { }”.format(score))
28
29 #Use the model to detect the user's tone, sentiment, and level of confidence in responses
30 predictions=model.predict(X_test_vect)
31
32 #Use the predictions to adjust the persuasive strategy accordingly
33 for prediction in predictions:
34 if prediction==‘hesitant’:
35 #Adjust the persuasive strategy to be more persuasive
36 else:
37 #Use the default persuasive strategy

The model is then evaluated to determine its accuracy, and used to detect the user's tone, sentiment and level of confidence in their responses. This information can then be used to adjust the persuasive strategy of the RPA chatbot accordingly, to maximize the likelihood of the user accepting the AI's decision.

In still a further example of reduction to practice, the following code snippet utilizes the Scikit-Learn library to train a classification model on user data, and then uses the model outputs to configure an RPA chatbot. Specifically, the code sets up the chatbot to interpret the model outputs and use them to determine the most appropriate persuasive strategy for the user. For example, the RPA chatbot will use the classification model's output to decide if it should use an authoritative or persuasive strategy when persuading the user:
1 #Import Libraries
2 import pandas as pd
3 import numpy as np
4
5 #Load the data
6 data=pd.read_csv(‘data.csv’)
7
8 #Train Classifier Model
9 from sklearn.svm import SVC
clf=SVC( ).fit(X,y)
11
12 #Set Up Chatbot
13 def configure_chatbot(classification_model)
14 #Set up the chatbot to interpret the model outputs
15 if classification_model==‘authoritative’:
16 chatbot.set_strategy(‘authoritative’)
17 elif classification_model==‘persuasive’:
18 chatbot.set_strategy(‘persuasive’)
19 else:
chatbot.set_strategy(‘neutral’)
21
22 #Execute Configuration
23 configure_chatbot(clf.predict(data)

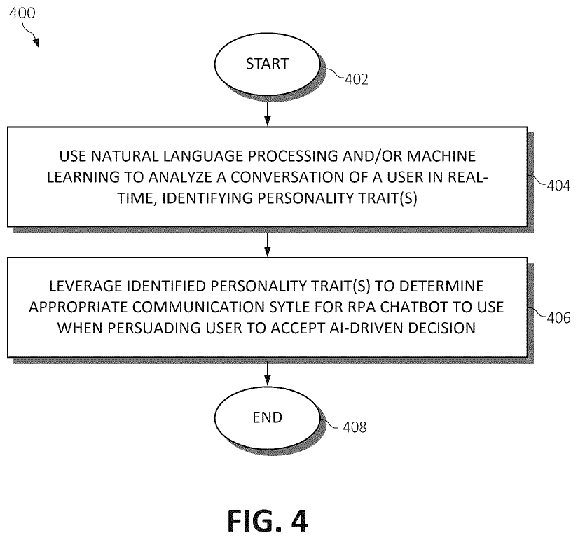

Turning now to FIG. 4, method 400 is depicted by an additional flow chart for optimizing RPA techniques. Method 400 begins (step 402) by analyzing, by one or more processors, a conversation of a user in real-time utilizing at least one of natural language processing (NLP) and machine learning, wherein the analyzing identifies one or more personality traits of the user (step 404). The one or more processors determine an appropriate communication style configured to be used an RPA chatbot to use when persuading the user to accept an Artificial Intelligence (AI) driven decision by leveraging the identified one or more personality traits (step 406). The method 400 then ends (step 408).

It should be noted that, as used herein, the terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for optimizing Robotic Process Automation (RPA), comprising:
analyzing, by one or more processors, a conversation of a user in real-time utilizing at least one of natural language processing (NLP) and machine learning, wherein the analyzing identifies one or more personality traits of the user;
determining, by the one or more processors, an appropriate communication style for an RPA chatbot to use when persuading the user to accept an Artificial Intelligence (AI) driven decision by leveraging the identified one or more personality traits; and
configuring, by the one or more processors, the RPA chatbot to use the determined appropriate communication style for the user.

2. The computer-implemented method of claim 1, further comprising:
storing, by the one or more processors, a decision-making history of the user in a database;
retrieving, by the one or more processors, the decision-making history from the database; and
utilizing, by the one or more processors, the decision-making history to analyze the conversation and a plurality of subsequent conversations inclusive of at least one of a behavior and a choice of the user over time, wherein a customized persuasive strategy of the RPA chatbot is generated for the user and additional users.

3. The computer-implemented method of claim 2, further comprising creating an AI model to accurately predict the at least one of the behavior and the choice of the user.

4. The computer-implemented method of claim 3, wherein creating the AI model further includes using one or more classifications, clustering, decision trees, and reinforcement learning techniques to predict the at least one of the behavior and the choice of the user.

5. The computer-implemented method of claim 4, further comprising using the AI model to develop at least one parameter to be used by the RPA chatbot.

6. The computer-implemented method of claim 5, further comprising configuring the RPA chatbot with the at least one parameter, including at least one of a user language and a sentiment preference of the user.

7. The computer-implemented method of claim 1, further comprising continuing to monitor user interactions and responses, using data gleaned from the interactions and responses to refine the determined appropriate communication style to maximize a likelihood of the user accepting the AI driven decision.

8. A system for optimizing Robotic Process Automation (RPA) in a computing environment, comprising:
one or more processors; and
one or more memory storing executable instructions, wherein the executable instructions, when executed, cause the one or more processors to:
analyze a conversation of a user in real-time utilizing at least one of natural language processing (NLP) and machine learning, wherein the analyzing identifies one or more personality traits of the user;
determine an appropriate communication style for an RPA chatbot to use when persuading the user to accept an Artificial Intelligence (AI) driven decision by leveraging the identified one or more personality traits; and
configure the RPA chatbot to use the determined appropriate communication style for the user.

9. The system of claim 8, wherein the executable instructions, when executed, further cause the one or more processors to:
store a decision-making history of the user in a database;
retrieve the decision-making history from the database; and
utilize the decision-making history to analyze the conversation and a plurality of subsequent conversations inclusive of at least one of a behavior and a choice of the user over time, wherein a customized persuasive strategy of the RPA chatbot is generated for the user and additional users.

10. The system of claim 9, wherein the executable instructions, when executed, further cause the one or more processors to create an AI model to accurately predict the at least one of the behavior and the choice of the user.

11. The system of claim 10, wherein the executable instructions, when executed, further cause the one or more processors to, pursuant to creating the AI model, use one or more classifications, clustering, decision trees, and reinforcement learning techniques to predict the at least one of the behavior and the choice of the user.

12. The system of claim 11, wherein the executable instructions, when executed, further cause the one or more processors to use the AI model to develop at least one parameter to be used by the RPA chatbot.

13. The system of claim 12, wherein the executable instructions, when executed, further cause the one or more processors to configure the RPA chatbot with the at least one parameter, including at least one of a user language and a sentiment preference of the user.

14. The system of claim 8, wherein the executable instructions, when executed, further cause the one or more processors to continue to monitor user interactions and responses, using data gleaned from the interactions and responses to refine the determined appropriate communication style to maximize a likelihood of the user accepting the AI driven decision.

15. A computer program product for optimizing Robotic Process Automation (RPA), the computer program product comprising:
one or more computer readable storage media, and program instructions collectively stored on the one or more computer readable storage media, the program instructions comprising:
program instructions to analyze a conversation of a user in real-time utilizing at least one of natural language processing (NLP) and machine learning, wherein the analyzing identifies one or more personality traits of the user;
program instructions to determine an appropriate communication style for an RPA chatbot to use when persuading the user to accept an Artificial Intelligence (AI) driven decision by leveraging the identified one or more personality traits; and
program instructions to configure the RPA chatbot to use the determined appropriate communication style for the user.

16. The computer program product of claim 15, further including program instructions to:
store a decision-making history of the user in a database;
retrieve the decision-making history from the database; and
utilize the decision-making history to analyze the conversation and a plurality of subsequent conversations inclusive of at least one of a behavior and a choice of the user over time, wherein a customized persuasive strategy of the RPA chatbot is generated for the user and additional users.

17. The computer program product of claim 16, further including program instructions to at least one of:
create an AI model to accurately predict the at least one of the behavior and the choice of the user, and
pursuant to creating the AI model, use one or more classifications, clustering, decision trees, and reinforcement learning techniques to predict the at least one of the behavior and the choice of the user.

18. The computer program product of claim 17, further including program instructions to use the AI model to develop at least one parameter to be used by the RPA chatbot.

19. The computer program product of claim 16, further including program instructions to configure the RPA chatbot with the at least one parameter, including at least one of a user language and a sentiment preference of the user.

20. The computer program product of claim 15, further including program instructions to monitor user interactions and responses, using data gleaned from the interactions and responses to refine the determined appropriate communication style to maximize a likelihood of the user accepting the AI driven decision.
